(19) United States
(12) Patent Application Publication
(10) Pub. No.: US 2023/0270120 A1
(43) Pub. Date: Aug. 31, 2023

(54) A METHOD OF CONTROLLING PEST

(71) Applicants: UPL do Brasil Industria e Comercio de Insumos Agropecuarios S.A., Ituverava (BR); UPL Corporation Limited, Port Louis (MU)

(72) Inventors: Sean Whipple, Concord Township, OH (US); Alessandro Mariani, West Palm Beach, FL (US); Luigi Avella, Fondi (IT)

(21) Appl. No.: 18/006,052

(22) PCT Filed: Jul. 30, 2021
(86) PCT No.: PCT/BR2021/050321

§ 371 Date: Jan. 19, 2023

(30) Foreign Application Priority Data
Jul. 30, 2020 (BR) 10 2020 015532-6
Jul. 30, 2021 (BR) 10 2021 015096-3

(51) Int. Cl. A01N 65/20; A01P 7/04; A01N 43/90; A01N 45/00; A01N 43/40; A01N 43/16

(52) U.S. Cl. CPC A01N 65/20; A01P 7/04; A01N 43/90; A01N 45/00; A01N 43/40; A01N 43/16

(57) ABSTRACT

The present invention relates to a method of controlling Euschistus heros, order Hemiptera, family Pentatomidae, by using an extract derived from Sophora flavescens and/or Sophora alopecuroides plants.

### CROSS REFERENCE TO RELATED APPLICATIONS

This application is a National Stage application of PCT/BR2021/050321, filed Jul. 30, 2021, which claims priority to Brazilian Patent Application No. 102020015532-6, filed Jul. 30, 2020 and Brazilian Patent Application No. 102021015096-3, filed Jul. 30, 2021, both of which are incorporated by reference in their entirety herein.

### FIELD OF INVENTION

The present invention relates to a method of controlling Euschistus heros, order Hemiptera, family Pentatomidae, by applying an extract derived from Sophora flavescens and or Sophora alopecuroides to plants.

### BACKGROUND

Euschistus heros is an economically important insect, belonging to neotropical species widespread in all South America, which can cause serious damage to several host plants such as soybean, beans, cotton, sunflower and other plant species belonging to the Fabaceae and Brassicaceae families.

Euschistus heros, as well as other Hemiptera Pentatomide, such as Halyomorpha halys, can be an invasive species due to its growing abundance, the world-wide trade of infested goods, the capability of insects to adapt to different climates and diet changes, and the development of resistance to various chemicals used for their control.

Euschistus heros is generally difficult to control, and its populations can surpass acceptable damage thresholds by sucking sap from different parts of the host plants such as the pods and stems of soybean. The control of Euschistus heros populations has become a significant issue for soybean and cotton growers due to the limited number of registered, effective mode of actions (active ingredients chemical groups/sub-groups) to control Euschistus heros and also due to the capability of Euschistus heros to develop resistance to several active ingredients. The number of resistance cases reported for different active ingredient groups such as organophosphates (IRAC 1B), cyclodiene organochlorines (IRAC 2A), synthetic pyrethroids (IRAC 3A) and neonicotinoids (IRAC 4) continue to increase and new methods for controlling this pest is a dire need.

Euschistus heros, is widely prevalent and distributed in Brazil, from the Northeast (West of the state of Bahia) to the Southern Region, including the state of Rio Grande do Sul, and in Paraguay as well. Because of their high population density and high number of generations (4) per year, multiple chemical control sprays are needed every growing season.

These insects vary in their susceptibility to insecticides. The variability in species-specific impact on crops, susceptibility to various insecticides, and general ecology underscore the need for an integrated approach to managing Euschistus heros. Insecticide active ingredient groups commonly used to control Euschistus heros include pyrethroids-neonicotinoid mixtures and organophosphates, although pyrethroid-necotinoid mixtures are usually the method of choice for controlling Euschistus heros in soybean. However, there are increasing problems with insecticide resistance across all registered chemistries.

Sophora flavescens and Sophora alopecuroides seeds and roots are used for medicinal purposes. The seeds and roots of S. flavescens and S. alopecuroides contain a number of quinolizidine alkaloids as the main ingredients. The important alkaloids are matrine, oxymatrine, aloperine, sophoridine, sophoramine and sophorcarpine. In addition to the alkaloids, a large number of flavonoids and related compounds and terpenes (terpenoids or isoprenoids) saponines (Saponosides) have also been found in the seeds and roots of Sophora Flavescens and or S. alopecuroides.

Considering the restricted number of effective insecticides with different modes of action (MoA) against Euschistus heros, there is a continuing need to find new methods of controlling these insect populations using biologically active compounds with superior properties (for example, greater biological activity, selective spectrum of activity, an increased safety profile), that are suitable for use in agriculture.

### SUMMARY

In one aspect, the present disclosure provides a method of controlling Euschistus heros by using a composition comprising an extract from Sophora flavescens, an extract from Sophora alopecuroides, or a combination thereof.

In yet another aspect, the present disclosure provides the use of a composition comprising an extract from Sophora flavescens, an extract from Sophora alopecuroides, or a combination thereof for controlling Euschistus heros.

### BRIEF DESCRIPTION OF THE DRAWING

FIGS. 1A and 1B show a comparative efficacy study was performed with the insecticide (chlorantraniliprole) and present composition (Sophora extract).

### DETAILED DESCRIPTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The term “insecticidally effective amount” is that quantity of an extract from Sophora flavescens, an extract from Sophora alopecuroides, or a combination thereof, applied in any amount which will provide the required control of insects. The selection of the proper quantity of an extract from Sophora flavescens, an extract from Sophora alopecuroides, or a combination thereof, to be applied, however, is within the expertise of one skilled in the art.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other ingredients not specifically recited therein.

Accordingly, the present invention provides a method of controlling Euschistus heros comprising contacting Euschistus heros pests with a composition comprising an extract from Sophora flavescens, an extract from Sophora alopecuroides, or a combination thereof.

In an embodiment, the compositions comprise an extract from Sophora flavescens, an extract from Sophora alopecuroides, or a combination thereof.

Typically, extracts from Sophora flavescens, Sophora alopecuroides, or a combination thereof, comprise up to 90% by the weight of an insecticidal composition that provides excellent insecticidal effect on Euschistus heros.

In an aspect, the Sophora extracts of the present disclosure may comprise alkaloids, flavonoids and other active organic compounds in the range of 0.001% to 99% by total weight of the composition.

In a specific embodiment, the Sophora extracts may be comprised of alkaloids and/or piscidic acid.

In an embodiment, the Sophora extracts may comprise one or more plant alkaloids selected from the group consisting of toosendanin, azadirachtin, tomatine, nicotine, matrine, oxymatrine, sophocarpine, sophoridine, N-oxysophocarpine, oxysophoridine, sophoranol, sophoramine, trifolirhizin, sophoraflavanone, cytisine, N-methyl cytisine, and aloperine.

Thus, in an embodiment, the insecticidal compositions of the present disclosure may comprise one or more plant alkaloids selected from the group consisting of toosendanin, azadirachtin, tomatine, nicotine, matrine, oxymatrine, sophocarpine, sophoridine, N-oxysophocarpine, oxysophoridine, sophoranol, sophoramine, trifolirhizin, sophoraflavanone, cytisine, N-methyl cytisine, and aloperine.

The plant alkaloids may be also be chemically synthesized at industrial scales in large amounts. Alternatively, the plant alkaloids may be extracted from natural raw materials from plants. The level of extraction and the degree of purity of the plant alkaloid may vary. For example, unpurified plant extracts may be employed in the insecticidal compositions. Depending on the solubility of the particular plant alkaloid in water or in organic solvent, the extraction process for each plant alkaloid may differ. Alternatively, the plant alkaloid may be partially purified or completely purified.

In an embodiment, the plant alkaloids used in the insecticidal compositions and method described herein are extracted from Sophora flavescens and/or Sophora alopecuroides, and can include one or more of matrine, oxymatrine, sophocarpine, N-oxysophocarpine, cytisine, N-methyl-cytisine and aloperine.

In an embodiment, the plant alkaloids are extracted from Sophora flavescens and/or Sophora alopecuroides.

In an embodiment, the insecticidal composition may comprise at least one quinolizinindine alkaloid as an active biopesticide compound derived from Sophora flavescens and/or Sophora alopecuroides.

The quinolizinidine alkaloid is particularly matrine and/or oxymatrine.

In an embodiment, the insecticidal compositions comprise matrine and/or oxymatrine.

The amount of matrine or oxymatrine in the insecticidal compositions may be widely varied and will typically be from about 0.1% to about 20% by volume, based on the total volume of the insecticidal composition. The preferred concentration will be from about 0.5% to about 10% by volume, based on the total volume of the insecticidal composition.

Typically, the concentration of Sophora alopecuroides extract in the insecticidal composition, when sprayed into the target field, is about 50 g/ha to 500 g/ha.

The insecticidal compositions may be used as a pesticide to prevent and protect plants from damages caused by Euschistus heros.

In another embodiment, included herein are methods for controlling and/or preventing infestation of the soybean crop by Euschistus heros.

The methods can be used for controlling Euschistus heros that are resistant to one or more other insecticides, preferably pyrethroid, neonicotinoids and organophosphates.

In an embodiment, the insecticidal composition of the present disclosure may be tank mixed and sprayed at a locus where one or more crop is growing, or may be alternatively be mixed with water, and then sprayed.

In an embodiment, the insecticidal compositions may be used for foliar application, ground application, or application to plant propagation materials.

In an embodiment, the insecticidal formulations of the present disclosure may typically be produced by mixing the Sophora alopecuroides extract in the composition with an inert carrier or adding surfactants or other adjuvants and carriers as needed and formulated into solid, or liquid formulations, including but not limited to wettable powders, granules, dusts, soluble (liquid) concentrates, suspension concentrates, oil in water emulsions, water in oil emulsions, emulsifiable concentrates, capsule suspensions, ZC formulations, oil dispersions, and other known formulation types.

Examples of the solid carrier used in formulation include, but are not limited to, fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide; and as a liquid carrier, include but not limited to aromatic hydrocarbons such as xylene, alkylbenzene and methylnaphthalene; alcohols such as 2-propanol, ethylene glycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include, but not limited to, anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include, but not limited to, water-soluble polymers such as polyvinyl alcohol and polyvinylpyrrolidone, polysaccharides such as Arabic gum, alginic acid and the salt thereof, CMC (carboxymethyl-cellulose), Xanthan gum, inorganic materials such as aluminum magnesium silicate and alumina sol, preservatives, coloring agents and stabilization agents such as PAP (acid phosphate isopropyl) and BHT.

In an embodiment, the method comprises applying to a crop of soybean plants, a locus thereof, or a propagation material thereof, an insecticidal composition comprising an extract of Sophora flavescens, an extract of Sophora alopecuroides, or a combination thereof, wherein the method is for controlling and/or preventing infestation of the soybean crop by Euschistus heros.

In a further aspect, provided is a method of controlling and/or preventing infestation of Euschistus heros in soybean and/or cotton plants comprising applying to a crop of soybean and/or cotton plants, a locus thereof, or a propagation material thereof, an insecticidal composition comprising an extract of Sophora flavescens, an extract of Sophora alopecuroides, or a combination thereof.

The present disclosure also relates to a method of protecting plants from attack or infestation by Euschistus heros comprising contacting a plant, or soil in which the plant is growing, with an insecticidal composition comprising an extract of Sophora flavescens, an extract of Sophora alopecuroides, or a combination thereof.

The disclosure also provides a method for the protection of plant propagation material, preferably seeds, and the seedlings' roots and shoots from Euschistus heros which comprises contacting the plant propagation material, for example, as the seeds before sowing and/or after pregermination with an insecticidal composition of present disclosure.

In an embodiment, the method comprises the use of the insecticidal compositions of the disclosure, including those prepared by premixing prior to application, e.g., as a ready mix or tank mix, or by simultaneous application or sequential application to the plant.

The insecticidal composition of the disclosure may be applied by any of the known means of applying pesticidal compounds. For example, it may be applied, formulated or unformulated, to the pests or to a locus of the pests (such as a habitat of the pests, or a growing plant liable to infestation by the pests) or to any part of the plant, including the foliage, stems, branches or roots, to the seed before it is planted or to other media in which plants are growing or are to be planted (such as soil surrounding the roots, the soil generally, paddy water or hydroponic culture systems), directly or it may be sprayed on, dusted on, applied by dipping, applied as a cream or paste formulation, applied as a vapor or applied through distribution or incorporation of a composition (such as a granular composition or a composition packed in a water-soluble bag) in soil or an aqueous environment.

The compositions of this disclosure may contain other compounds having biological activity, for example micronutrients or compounds having fungicidal activity or which possess plant growth regulating, herbicidal, insecticidal, nematicidal or acaricidal activity.

The Sophora flavescens and/or Sophora alopecuroides extracts may be the sole active ingredient of the composition or they may be admixed with one or more additional active ingredients such as an insecticide, acaricide, fungicide, synergist, herbicide or plant growth regulator where appropriate.

The application can be carried out both before and after the infestation of the crops, plants, plant propagation materials, such as seeds, soil, or the area, material or environment by the Euschistus heros pests.

Suitable application methods include inter alia soil treatment, seed treatment, in furrow application, and foliar application. Soil treatment methods include drenching the soil, drip irrigation (drip application onto the soil), dipping roots, tubers or bulbs, or soil injection. Seed treatment techniques include seed dressing, seed coating, seed dusting, seed soaking, and seed pelleting. In furrow applications typically include the steps of making a furrow in cultivated land, seeding the furrow with seeds, applying the composition to the furrow, and closing the furrow. Foliar application refers to the application of the composition to plant foliage, e.g., through spray equipment. For foliar applications, it can be advantageous to modify the behaviour of the pests by use of pheromones in combination with the compounds of the present invention. Suitable pheromones for specific crops and pests are known to a skilled person.

For use in treating crop plants, e.g., by foliar application, the rate of application of the insecticidal composition of this disclosure may be in the range of 0.0001 g to 4000 g per hectare.

In an embodiment, Sophora extract is efficacious at a dose rate of 100 g or ml/ha to 5000 g or ml/ha, preferably at a dose rate of 100 g or ml/ha to 4000 g or ml/ha, more preferably at a dose rate of 100 g or ml/ha to 3000 g or ml/ha, more specifically at a dose rate of 500 g or ml/ha to 2500 g or ml/ha.

The active substance concentrations in ready-to-use formulations, which may be obtained after two-to-tenfold dilution, are preferably from 0.01 to 60% by weight, more preferably from 0.1 to 40% by weight.

As used herein, the term “contacting” includes both direct contact (applying the compositions directly on the animal pest or plant—typically to the foliage, stem or roots of the plant) and indirect contact (applying the active compounds/compositions to the locus, i.e. habitat, breeding ground, plant, seed, soil, area, material or environment in which a pest is growing or may grow, of the animal pest or plant).

The term “crop” refers to both, growing and harvested crops.

The term “plant” includes cereals, e.g. durum and other wheat, rye, barley, triticale, oats, rice, or maize (fodder maize and sugar maize/sweet and field corn); beet, e.g., sugar beet or fodder beet; fruits, such as pomes, stone fruits or soft fruits, e.g., apples, pears, plums, peaches, nectarines, almonds, cherries, papayas, strawberries, raspberries, blackberries or gooseberries; leguminous plants, such as beans, lentils, peas, alfalfa or soybeans; oil plants, such as rapeseed (oilseed rape), turnip rape, mustard, olives, sunflowers, coconut, cocoa beans, castor oil plants, oil palms, ground nuts or soybeans; cucurbits, such as squashes, pumpkins, cucumber or melons; fiber plants, such as cotton, flax, hemp or jute; citrus fruit, such as oranges, lemons, grapefruits or mandarins; vegetables, such as eggplant, spinach, lettuce (e.g., iceberg lettuce), chicory, cabbage, asparagus, cabbages, carrots, onions, garlic, leeks, tomatoes, potatoes, cucurbits or sweet peppers; lauraceous plants, such as avocados, cinnamon or camphor; energy and raw material plants, such as corn, soybean, rapeseed, sugar cane or oil palm; tobacco; nuts, e.g. walnuts; pistachios; coffee; tea; bananas; vines (table grapes and grape juice grape vines); hop; sweet leaf; natural rubber plants or ornamental and forestry plants, such as flowers (e.g., carnation, petunias, geranium/pelargoniums, pansies and impatiens), shrubs, broad-leaved trees (e.g., poplar) or evergreens, e.g., conifers; eucalyptus; turf; lawn; grass such as grass for animal feed or ornamental uses. Preferred plants include potatoes sugar beets, tobacco, wheat, rye, barley, oats, rice, corn, cotton, soybeans, rapeseed, legumes, sunflowers, coffee or sugar cane; fruits; vines; ornamentals; and vegetables, such as cucumbers, tomatoes, beans and squashes.

The term “plant” is to be understood as including plants which have been modified by either conventional breeding, or mutagenesis or genetic engineering, or by a combination thereof.

The term “plant propagation material” refers to all the generative parts of the plant such as seeds and vegetative plant material such as cuttings and tubers (e.g., potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “seed” include seeds and plant propagules of all kinds including, but not limited to, true seeds, seed pieces, suckers, corms, bulbs, fruit, tubers, grains, cuttings, cut shoots and the like, and means in a preferred embodiment true seeds.

In general, “pesticidally effective amount” means the amount of the insecticidal composition comprising Sophora flavescens and or Sophora alopecuroides extracts needed to achieve an observable effect on growth, including the effects of necrosis, death, retardation, prevention, and removal, destruction, or otherwise diminishing the occurrence and activity of the target organism. Particularly, the present insecticidal composition of this disclosure is highly effective when applied at a dose of 100 g or ml/ha to 5000 g or ml/ha.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and following examples, but by all embodiments and methods within the scope and spirit of the invention.

### EXAMPLES

### Example 1

Efficacy of the Composition to Control Euschistus heros (E. heros) in Soybean.

### Method and Evaluation

Susceptible populations of E. heros were used in this trial. Dose rate of Sophora extracts applied was 1000 ml/ha.

Euschistus heros infestation was done 24 h before application. Applied present product comprising Sophora extract on Euschistus heros, in soybean crop. Mortality assessment was done at 1 DAA, 3 DAA and 7 DAA.

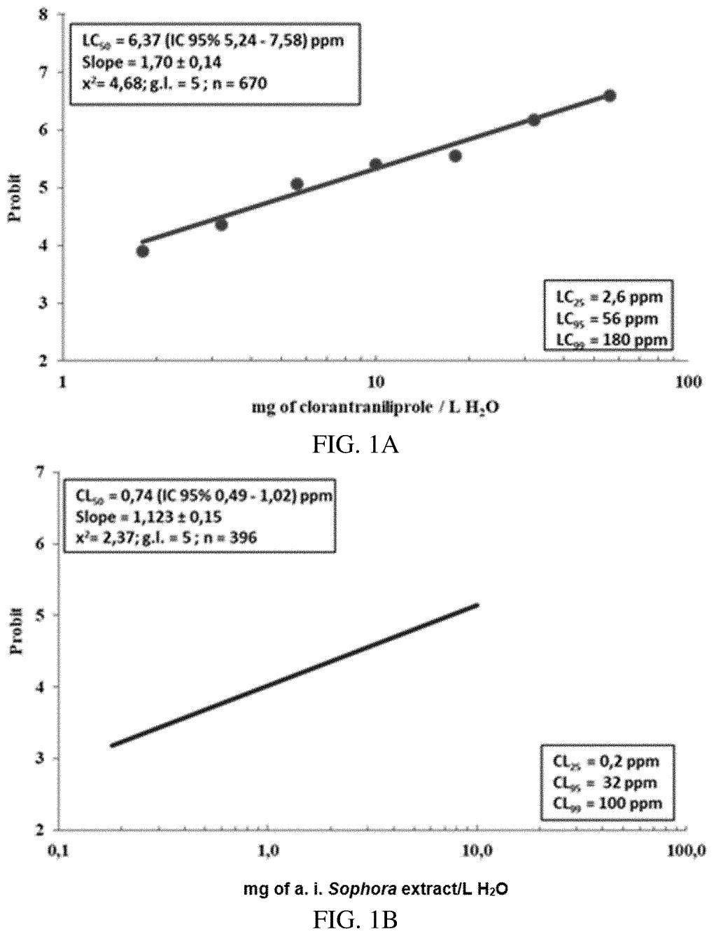

A further comparative efficacy study was performed with the insecticide (Chlorantraniliprole) and present composition (Sophora extract). The results are represented in FIGS. 1A and 1B.

It was concluded that the composition of the present invention comprising Sophora flavescens and/or Sophora alopecuroides extracts was about 1.8 times to 13 times more efficacious than Chlorantraniliprole in controlling Euschistus heros when compared using the lethal concentration (LC) values.

### Example 2

Efficacy of the Composition to Control Euschistus heros (E. heros) in Soybean.

### Method

A soybean plantation was sowed with the spacing used between rows was 0.5 m, and a planting density of 300,000 plants/ha. Twenty plots (20) with dimensions of 3.0 m wide×10.0 m long were used for the assembly of the test. At the time of the first spraying, the plants were in stage R4. 5 treatments were evaluated, including one control, four doses of the Sophora extract. A randomized block design was adopted with four replications, each repetition consisting of a plot of 3.0 m wide×10.0 m in length. Sprays of insecticide treatments were performed with foliar application, and the plants were in stages R4 and R5, respectively, according to the BBCH scale (2001). The applications were performed in this period, when the presence of the insect pest was verified. The evaluations were previously performed at 1, 3, 7 and 10 days after the first application (DAA1) and at 1, 3, 7 and 10 days after the second application (DAA2).

In each evaluation period, scores of the total number of nymphs and adults of E. heros were counted in 2 beaten cloths per plot (treatments), recording the total number of nymphs and adults in each plot. Then, the data of the sum of insect population densities per plot were transformed by square root of (x+0.5) and subsequently submitted to variance analysis and comparison of means by Tukey test. The significance level of the tests was 5% (Westfall, P. H., Tobias, R. D., Rom, D., Wolfinger, R. D., Hochberg, Y, Multiple Comparisons and Multiple Tests: Using the SAS System, SAS Institute Inc., Cary, N.C. (1999)).

The percentage of efficiency (E %) of each treatment was calculated using the Abbott formula (1925): E (%)={[1−(n T after application/n Co after application)*100}, where n T after application=contamination in insecticide treatment after application; and n Co after application=contamination in control after application and E (%)=Percentage of efficiency.

Phytotoxicity on culture was evaluated in all periods, using the ERWC scale (1964).

The productivity evaluation was carried out at the end of the experimental period and the plants of 8 m² of each experimental plot were harvested. Then, the data were submitted to variance analysis and comparison of means by Tukey test. The significance level of the tests was 5% (Westfall, P. H., Tobias, R. D., Rom, D., Wolfinger, R. D., Hochberg, Y, Multiple Comparisons and Multiple Tests: Using the SAS System, Cary, N.C. (1999)).

TABLE 1
% EFFICACY AGAINST NYMPHS OF EUSCHISTUS HEROS

| | | Efficacy | | | | | | | |
|---|---|---|---|---|---|---|---|---|---|
| | Dose g | 1 | 3 | 7 | 10 | 1 | 3 | 7 | 10 |
| Treatment | or ml/ha | DAA1 | DAA1 | DAA1 | DAA1 | DAA2 | DAA2 | DAA2 | DAA2 |
| Untreated | | | | | | | | | |
| Sophora | 750 | 68.42 | 78.26 | 72.73 | 75.76 | 86.36 | 100.00 | 100.00 | 100.00 |
| extract | | | | | | | | | |
| Sophora | 1000 | 78.95 | 86.96 | 72.73 | 84.85 | 95.45 | 96.30 | 93.10 | 100.00 |
| extract | | | | | | | | | |
| Sophora | 1500 | 78.95 | 95.65 | 86.36 | 96.97 | 95.45 | 100.00 | 100.00 | 97.44 |
| extract | | | | | | | | | |
| Sophora | 2000 | 73.68 | 82.61 | 86.36 | 96.97 | 100.00 | 96.30 | 96.55 | 92.31 |
| extract | | | | | | | | | |

TABLE 2
% EFFICACY AGAINST ADULTS OF EUSCHISTUS HEROS

| | | Efficacy | | | | | | | |
|---|---|---|---|---|---|---|---|---|---|
| | Dose g | 1 | 3 | 7 | 10 | 1 | 3 | 7 | 10 |
| Treatment | or ml/ha | DAA1 | DAA1 | DAA1 | DAA1 | DAA2 | DAA2 | DAA2 | DAA2 |
| Untreated | | | | | | | | | |
| Sophora | 750 | 85.71 | 76.92 | 80.00 | 56.25 | 85.71 | 88.89 | 100.00 | 100.00 |
| extract | | | | | | | | | |
| Sophora | 1000 | 85.71 | 84.62 | 80.00 | 81.25 | 100.00 | 100.00 | 100.00 | 100.00 |
| extract | | | | | | | | | |
| Sophora | 1500 | 85.71 | 84.62 | 100.00 | 100.00 | 100.00 | 100.00 | 87.50 | 100.00 |
| extract | | | | | | | | | |
| Sophora | 2000 | 64.29 | 84.62 | 100.00 | 81.25 | 100.00 | 100.00 | 100.00 | 100.00 |
| extract | | | | | | | | | |

TABLE 3
% INCREASE IN PRODUCTIVITY

| Treatment | Dose g or ml/ha | Productivity increase % |
|---|---|---|
| Untreated | | |
| Sophora extract | 750 | 19.94 |
| Sophora extract | 1000 | 37.76 |
| Sophora extract | 1500 | 34.89 |
| Sophora extract | 2000 | 39.33 |

The insecticidal Sophora extract at doses of 750, 1000, 1500 and 2000 mL/ha is efficient in the control of E. heros nymphs up to 10 days after the second application in soybean crop. And for the control of adults of E. heros the products are efficient in all doses up to 10 days after the second application in soybean crop.

Moreover, products tested at different doses did not cause symptoms of phytotoxicity to soybean crop. The insecticide in all doses evaluated, and the patterns did not negatively affect soybean yield. And the treatment with Sophora extract at the dose 2000 mL/ha showed the greatest increase in productivity.

### Example 3

Efficacy of the Composition to Control Nymphs of Euschistus heros (E. heros) in Soybean.

### Method

Plots composed of 14 lines of culture with 8 meters long (48 m²m).

Treatment was done with 192 m². Spacing between culture lines of 0.45 m.

For the application of the treatments, a constant pressure (CO₂) costal spray equipped with a 3.0 m bar, equipped with 6 tapered jet tips, spaced 50 cm, at a height of 50 cm from the desired target, was used. Spray volume of 150 L ha-1, pressure of 3 bar was used. The design used was randomized blocks (DBC), with 4 replications.

The count of nymphs of Euschistus heros was performed in 2 cloth beats per plot at 0 (previous), 1 and 3 days after the application.

The data were transformed into Root of X+0.5, being compared by the Tukey test at 5% probability, with the aid of the SasmAgri program (Canteri, Marcelo & Althaus, Romulo & Virgens Filho, Jorim & Giglioti, Eder & Godoy, Claudia. (2001). SASM-AGRI-SYSTEM FOR ANALYSIS AND MEAN SEPARATION IN AGRICULTURAL ASSAYS USING SCOTT-KNOTT, TUKEY AND DUNCAN METHODS. Revista Brasileira de Agrocomputação. 1. 18-24). Efficiency was calculated by Abbott's formula (1925).

Efficacy

| Treatment | Dose g or ml/ha | 1 DAA | 3 DAA |
|---|---|---|---|
| Untreated | | | |
| Sophora extract | 750 | 33.3 | 100 |
| Sophora extract | 1000 | 66.7 | 100 |
| Sophora extract | 1500 | 100 | 100 |
| Sophora extract | 2000 | 100 | 100 |

### Example 4

Efficacy of the Composition to Control Adults of Euschistus heros (E. heros) in Soybean.

For the test an area of 1200 m² of soybeans was prepared.

Soybean was sowed according to a spacing of 0.45 cm between rows, with about 12 plants per meter. Each plot contained 6 m in length×4 m wide (24 m²), nine lines per plot in a total of 20 plots. The experimental design was randomized blocks (DBC), composed of 5 treatments and four replications. During the trial, the cultural tracts normally recommended for culture were maintained.

Approximately three months after planting, with soybean already in reproductive phase (R4/R5) and with adequate incidence of stink bugs, a previous evaluation was performed in all plots (0 DAA). After the presence of adults of E. heros on the plants was verified, an application was performed (volume of spray of 150 L/ha) with the different treatments, using an experimental costal spray, propelled by CO₂ tablet, equipped with fourtips jet fan and with the working pressure of 4 bar. Foliar application was done.

The efficacy of the products in the control of adults of E. heros in soybean crop was determined by the Abbott formula (Nakano, O. S. Silveira Neto & R. A. Zucchi. 1981. Entomologia econômica, Piracicaba, ESALQ, 314p) as described below:

% E=(1−I/C)×100

In which:
% E=Control efficacy; C=number of E. heros alive in the control; I=number of Live E. heros in the evaluated treatment.

| | Efficiency (%) |
|---|---|
| Treatment (g mL/ha) | 1 DAA |
| Untreated | 0.00 |
| Sophora extract (750) | 50.00 |
| Sophora extract (1000) | 75.00 |
| Sophora extract (1500) | 100.00 |
| Sophora extract (2000) | 100.00 |

Thus, it can be concluded from the above examples that Sophora extracts are effective in controlling the nymphs and adult insects of E. heros while also increasing the yield/productivity of the crop.

1. A method of controlling Euschistus heros, comprising contacting Euschistus heros pests with an insecticidal composition comprising an extract from Sophora flavescens, an extract from Sophora alopecuroides, or a combination thereof.

2. The method as claimed in claim 1, wherein the said insecticidal composition further comprises one or more plant alkaloids selected from the group consisting of toosendanin, azadirachtin, tomatine, nicotine, matrine, oxymatrine, sophocarpine, sophoridine, N-oxysophocarpine, oxysophoridine, sophoranol, sophoramine, trifolirhizin, sophoraflavanone, cytisine, N-methyl cytisine, and aloperine.

3. The method as claimed in claim 2, wherein the said one or more plant alkaloids are extracted from Sophora flavescens, Sophora alopecuroides, or a combination thereof.

4. The method as claimed in claim 1, wherein the said insecticidal composition comprises at least one quinolizinindine alkaloid as an active biopesticide compound extracted from Sophora.

5. The method as claimed in claim 4, wherein the said quinolizinidine alkaloid is matrine, oxymatrine, or a combination thereof.

6. A method of controlling and/or preventing infestation of Euschistus heros in soybean and/or cotton, comprising applying to a crop of soybean and/or cotton plants, a locus thereof, or a propagation material thereof, a composition comprising an extract from Sophora flavescens, an extract from Sophora alopecuroides, or a combination thereof.

7. The method of claim 1, comprising contacting a plant, or soil in which the plant is growing, with the composition of claim 1 wherein contacting protects the plants from attack or infestation by Euschistus heros.

8. The method of claim 1 comprising contacting a plant propagation material with the composition of claim 1, wherein contacting protects the plant propagation material from attack or infestation by Euschistus heros.

9. (canceled)

10. The method as claimed in claim 7, wherein the composition is applied to soybean and/or cotton plants.

11. The method of claim 8, wherein the plant propagation material is seeds.
